(19) United States
(12) Patent Application Publication
(10) Pub. No.: US 2010/0333213 A1
(43) Pub. Date: Dec. 30, 2010

(54) Systems and Methods for Determining Authorization to Operate Licensed Software Based on a Client Device Fingerprint

(76) Inventor: Craig Stephen Etchegoyen, Irvine, CA (US)

Correspondence Address: Uniloc USA Inc., 2151 Michelson Ste. 100, Irvine, CA, 92612, US

(21) Appl. No.: 12/792,461

(22) Filed: Jun. 2, 2010

Related U.S. Application Data
(60) Provisional application No. 61/220,096, filed on Jun. 24, 2009.

(51) Int. Cl. G06F 7/04; G06F 15/173; G06F 21/22

(52) U.S. Cl. 726/29; 709/224

(57) ABSTRACT

Methods and systems disclosed herein may be used to determine if licensed software has been previously installed or used on a device by monitoring an identifier associated with the device on which the licensed software is to be installed or used. Prior to operation of licensed software, a client device requires authorization from a license server. The license server may retrieve a unique identifying device fingerprint from the client device to authorize installation of the software based on a probabilistic comparison of the identifier with stored device identifiers subject to a license. If the comparison yields a match and if total instances of retrieval of the retrieved device fingerprint does not exceed licensed rights, the authorization is granted.

This application claims priority to U.S. Provisional Application No. 61/220,096 which was filed Jun. 24, 2009 and which is fully incorporated herein by reference.

### FIELD OF THE INVENTION

The present disclosure relates to systems and methods for monitoring operations of licensed software and, more particularly, to systems and methods for determining if a licensed software has been previously used on a computer by monitoring an identifier associated with the computer on which the licensed software is to be used.

### DESCRIPTION OF RELATED ART

Traditionally, software publishers have generated revenue for their proprietary software through selling licenses to end-users. The hallmark of proprietary software licenses is that the software publisher grants a license to use one or more copies of software, but that ownership of those copies remains with the software publisher. One consequence of this feature of proprietary software licenses is that virtually all rights regarding the software are reserved by the software publisher and only a limited set of well-defined rights are conceded to the end-user. An example of such proprietary software license is a limited license agreement through which software is purchased with limits and restrictions on the number of copies available for installation or use.

Limited licenses are sometimes limited to a designated number of computers or to a specific number of users operating the software. Some limited licenses may restrict use to certain computing facilities, such as educational institutional facilities where the software is licensed for use solely in support of classroom instruction and/or research activities.

Despite these licenses, piracy remains an ever-present threat to software publishers. Acts of piracy may include mass counterfeiting schemes, loading a single licensed copy of software onto multiple machines, and/or the creation of backup copies. Although software publishers have focused on incorporating security measures into software to prevent software piracy, hackers and pirates typically and eventually find ways to bypass or circumvent these security measures.

An ordinary software user is typically not as sophisticated as software hackers and pirates. Although the ordinary software user may install pirated software on a computer, the user typically does not change the computer settings and other installed components on the computer. Accordingly, there is a need for security measures that would eliminate software piracy based on components on a user's computer.

### SUMMARY OF THE INVENTION

Methods and systems disclosed herein may be used to determine if licensed software has been previously installed or used on a device by monitoring an identifier associated with the device on which the licensed software is to be installed or used. Prior to operation of licensed software, a client device requires authorization from a license server. The license server may retrieve a unique identifying device fingerprint or device identifier from the client device in order to authorize installation of the software.

An embodiment of the present invention is directed to an apparatus, including a network interface to connect to at least one client device through a computer network. The apparatus also includes a processor configured to retrieved a device fingerprint that uniquely identifies a client device seeking authorization to operate software. The apparatus further includes a memory comprising program instructions operable to: associate a value with the retrieved device fingerprint; probabilistically compare the value to previously stored device fingerprints and to determine if the retrieved device fingerprint matches a previously stored device fingerprint; determine if a number of times the retrieved device fingerprint is obtained for a given license identifier exceeds a pre-determined threshold; authorize a client request for access to software associated with the license identifier if the number of times is within license parameters associated with the license identifier; and store the retrieved device fingerprint. The processor is configured to operate the program instructions.

Another embodiment of the invention is directed to a method including connecting a server to at least one client device through a computer network and retrieving a device fingerprint that uniquely identifies a client device seeking authorization to operate software. The method also includes associating a value with the retrieved device fingerprint, probabilistically comparing the value to previously stored device fingerprints and determining if the retrieved device fingerprint matches a previously stored device fingerprint and determining if a number of times the retrieved device fingerprint is obtained for a given license identifier exceeds a pre-determined threshold. The method further includes in response to the determining, authorizing a client request for access to software associated with the license identifier if the number of times is within license parameters associated with the license identifier and storing the retrieved device fingerprint.

Another embodiment of the invention is directed to an apparatus including means for connecting to at least one client device through a computer network and means for retrieving a device fingerprint that uniquely identifies a client device seeking authorization to operate software. The apparatus also includes means for associating a value with the retrieved device fingerprint, means for probabilistically comparing the value to previously stored device fingerprints and determining if the retrieved device fingerprint matches a previously stored device fingerprint and means for determining if a number of times the retrieved device fingerprint is obtained for a given license identifier exceeds a pre-determined threshold. The apparatus further includes in response to the determining, means for authorizing a client request for access to software associated with the license identifier if the number of times is within license parameters associated with the license identifier and means for storing the retrieved device fingerprint.

Another embodiment of the invention is directed to a computer-readable medium having stored thereon, computer-executable instructions that, if executed by a computing device, cause the computing device to perform a method including connecting a server to at least one client device through a computer network, retrieving, by the server, a device fingerprint that uniquely identifies a client device seeking authorization to operate software, associating, by the server, a value with the retrieved device fingerprint, probabilistically comparing, by the server, the value to previously stored device fingerprints and determining if the retrieved device fingerprint matches a previously stored device fingerprint, determining, by the server, if a number of times the retrieved device fingerprint is obtained for a given license identifier exceeds a pre-determined threshold, in response to the determining, authorizing, by the server, a client request for access to software associated with the license identifier if the number of times is within license parameters associated with the license identifier and storing, by the server, the retrieved device fingerprint.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention, wherein:

FIG. 1 illustrates one embodiment of a system for determining if licensed software has been previously installed or used on a client device;

FIG. 2 illustrates another embodiment of a system for dynamically determining whether licensed software may be installed or used by a client device; and

FIG. 3 illustrates an implementation of an embodiment of the invention.

### DETAILED DESCRIPTION

Methods, systems, and other aspects of the invention are described in more detail below. Reference will be made to certain embodiments of the invention, examples of which are illustrated in the accompanying drawings. While this invention will be described in conjunction with the embodiments, it will be understood that it is not intended to limit the invention to these particular embodiments. On the contrary, the invention is applicable to alternatives, modifications and equivalents that are within the spirit and scope of the invention. The specification and drawings are, accordingly, to be regarded in an illustrative rather than a restrictive sense. Moreover, in the following description, numerous specific details are set forth to provide a thorough understanding of the invention. However, it will be apparent to one of ordinary skill in the art that the disclosed embodiments and alternatives may be practiced without these particular details. In other instances, methods, procedures, components, and networks that are well known to those of ordinary skill in the art are not described in detail to avoid obscuring aspects of the present invention.

According to certain embodiments, methods and systems may be used to determine if licensed software has been previously operated on a device. The determination may be made by monitoring an identifier associated with the device on which the licensed software is to be installed or used. The systems and methods may comprise both server-side and client-side components, and one of ordinary skill in the art will find that there are a variety of ways to design a client or server architecture. Therefore, the systems and methods disclosed herein are not limited to a specific client or server architecture, and encompass variations and modifications embodying the inventive systems and methods disclosed herein.

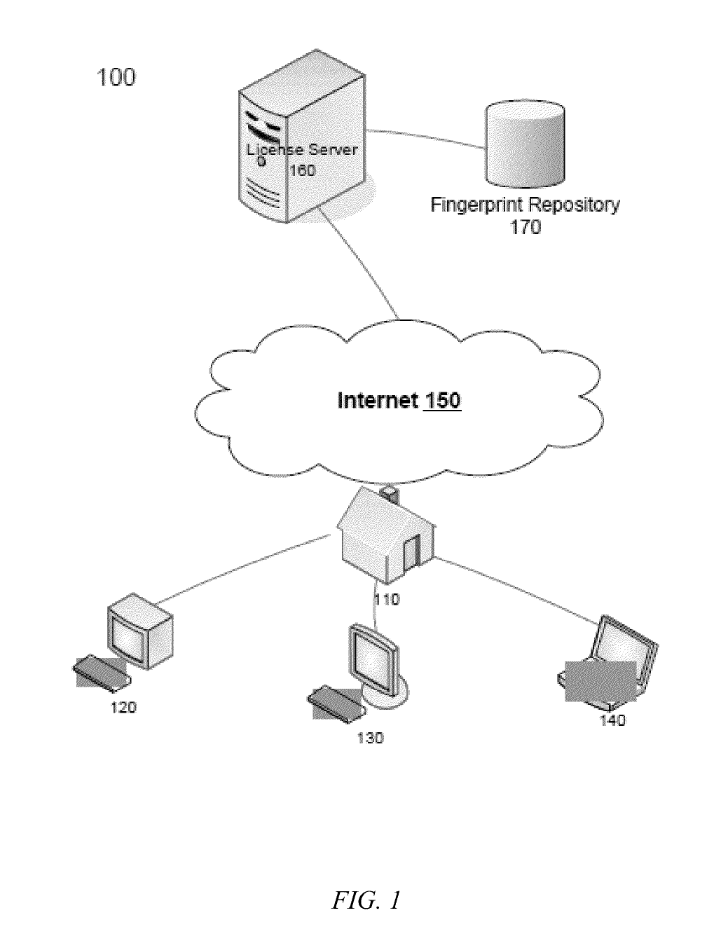

FIG. 1 illustrates one embodiment of a system 100 for determining if licensed software has been previously installed or used on client device(s) 120, 130, and/or 140. Although the example in FIG. 1 illustrates client devices 120, 130, 140 as being part of a local area network (LAN) 110 associated with a single household, it is understood that they may not be so associated.

Client devices 120, 130, 140 are depicted to be in communication with a license server 160 via a communications network 150. In certain embodiments, client devices 120, 130 and 140 may be connected to license server 160 through the Internet. As is known to those skilled in the art, in order for client devices 120, 130 and 140 to connect to license server 160 through the Internet, each client device 120, 130 and 140 may execute a browser application where web pages or applications associated with license server 160 may be loaded.

If a client device requires authorization from license server 160 prior to installing licensed software, during installation of the software, license server 160 may retrieve a unique identifying device fingerprint from the client device in order to authorize installation of the software. Similarly, if a client device requires authorization from license server 160 prior to use of licensed software, license server 160 may retrieve the unique device fingerprint from the client device in order to authorize use of the software. For example, license server 160 may retrieve the device fingerprint from client device 120, 130, 140 for license server 160 to determine if granting authorization for client device 120, 130, 140 to install or use the software would comply with limits associated with the software license. If the license server 160 determines that granting an installation or use authorization to the client device would be within the software license limit, then an unlock key may be generated by license server 160 and communicated to the client device.

Upon receiving the unlock key from license server 160, client device 120, 130 and 140 may then install or use the software. The licensed software may be downloaded from a remotely-located server or encoded in a computer-readable media of a data storage device which, when loaded onto client device 120, 130, 140, causes client device 120, 130, 140 to perform the client-side processes and outputs.

If license server 160 determines that granting authorization to client device 120, 130, 140 would not comply with the software license limit, then license server 160 may provide client device 120, 130, 140 with an option to purchase additional installation or usage rights or license server 160 may deny the request and the software installation or execution on the client device may be terminated.

According to certain embodiments, prior to requesting authorization from license server 160, client device 120, 130, 140 may execute the web browser and load an identification web page associated with the license server 160. The identification web page may be executed from license server 160. Upon client device 120, 130, 140 loading the identification web page, license server 160 may examine client device 120, 130, 140 for a browser-based forensic fingerprint. In certain embodiments the browser-based forensic fingerprint may include the IP address of client device 120, 130, 140, the version of the browser being executed by client device 120, 130, 140 and a list of any software exposed to the browser being executed by client device 120, 130, 140. Examples of listings of browser visible software may include cached images, history, cookies and other visible browser settings. It should be apparent to one skilled in the art, that the forensic fingerprint may include other elements in addition to or instead of those listed above.

License server 160 may then associate a value with the obtained forensic fingerprint. The value may be examined using a probabilistic model and compared to previously stored fingerprints to determine if the newly obtained fingerprint is equal to a previously stored fingerprint. For example, the probabilistic model may determine that the obtained forensic fingerprint is equal to a previously stored fingerprint for a client device where the IP address was previously stored and where a percentage of the obtained browser visible software was also previously stored and associated with the stored IP address. Thus, with a fair amount of accuracy, server 160 may determine if the obtained fingerprint matches a previously stored fingerprint, even if one or more components on the client device has been removed or changed.

License server 160 may determine if the number of times a unique device fingerprint is retrieved for a given license identifier exceeds a given threshold as determined by an associated software license. License server 160 may then authorize client requests for access to software associated with a license if license server 160 determines that the number of times a unique device fingerprint is retrieved for a given license identifier is within the parameters of the software license. License server 160 stores each obtained fingerprint in an associated fingerprint database 170 to be used in determining whether future authorization requests should be granted or denied.

Because, in certain embodiments, the components of the fingerprint are visible to a browser application, the fingerprint may be obtained from client device 120, 130, 140 without the need to install additional software on the client device. There is also no need for client device 120, 130, 140 to submit to additional security checks or additional software installations.

Client devices 120, 130, 140 may be any device or machine capable of communicating with a communications network 150. Preferably, the client device may include a processor that is operatively connected to a memory and a display to operate the software. Thus, suitable client devices include game consoles, personal desktop computers, portable laptop computers, server computers, tablet computers, personal digital assistants, mobile phones, wireless communication devices, onboard vehicle computers, and the like.

The communications network 150 may comprise the Internet, a cellular communications network, a satellite communications network, a local area network, or a combination of these or other suitable network.

The license server 160 may include one or more processors configured to receive device fingerprint and license data and ascertain the particular license rights pertaining to the client device. The license server 160 may also include memory for storing programming instructions and/or data. License server 160 may be in communication with a fingerprint database 170 comprising stored licensed rights corresponding to a plurality software licenses and device fingerprints. The information in database 170 permits license server 160 to ascertain whether a particular device fingerprint corresponding to a client device is covered under a license to the software. The information in database 170 further permits license server 160 to ascertain the number of different device fingerprints which have been authorized to install or operate the licensed software.

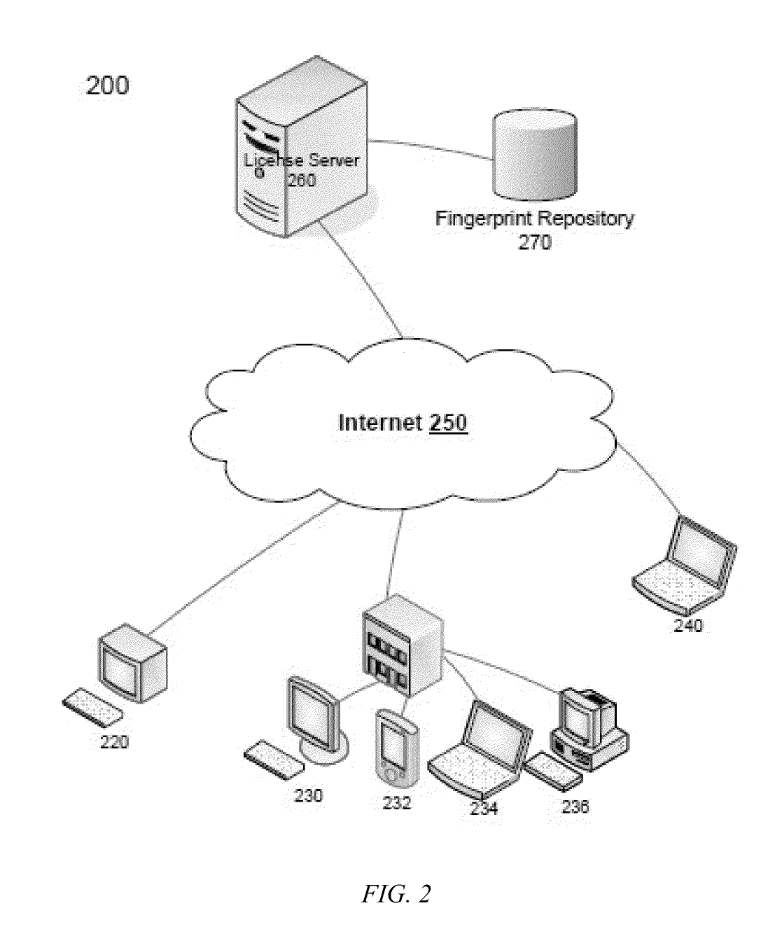

FIG. 2 illustrates another embodiment of a system 200 for dynamically determining whether licensed software is to be operated by a client device. Client devices may be independent of other client devices and may be located in a different location, for example as shown with devices 220 and 240, or independent client devices may be located in one location, for example as shown with devices 230-236. Client devices 220-240 are shown to be in communication with a license server 260. License server 260 may retrieve a uniquely device fingerprint associated with each client device 220-240 via a communications network 250.

License server 260 may determine if the number of times a unique device fingerprint is retrieved for a given license identifier exceeds a given threshold. The threshold may be a pre-defined number associated with licensed software as determined by the licensor or software publisher. For example, if client device 220 is associated with a single use license, license server 260 may determine if the device fingerprint associated with client device 220 was previously stored. If it is determined that client device 220 is attempting to reinstall software associated with a single use license, because the device fingerprint was previously stored, then license server 260 may deny the installation request and terminate installation of the software. In another example, if client devices 230-236 are associated with a multi-use license, license server 260 may determine if the device fingerprints associated with client devices 230-236 were previously stored and if the number of installations requested by client devices 230-236 exceeds a threshold associated with the software license. License server 260 may permit installation of the software on client devices 230-236 until the threshold associated with the multi-use license is exceeded. In the case of a multi-use license, multiple client devices such as client devices 230-236 may be associated with a single software license and the device fingerprints of each of devices client devices 230-236 may be used by license server 260 to determine if the threshold associated with the multi-use license is exceeded.

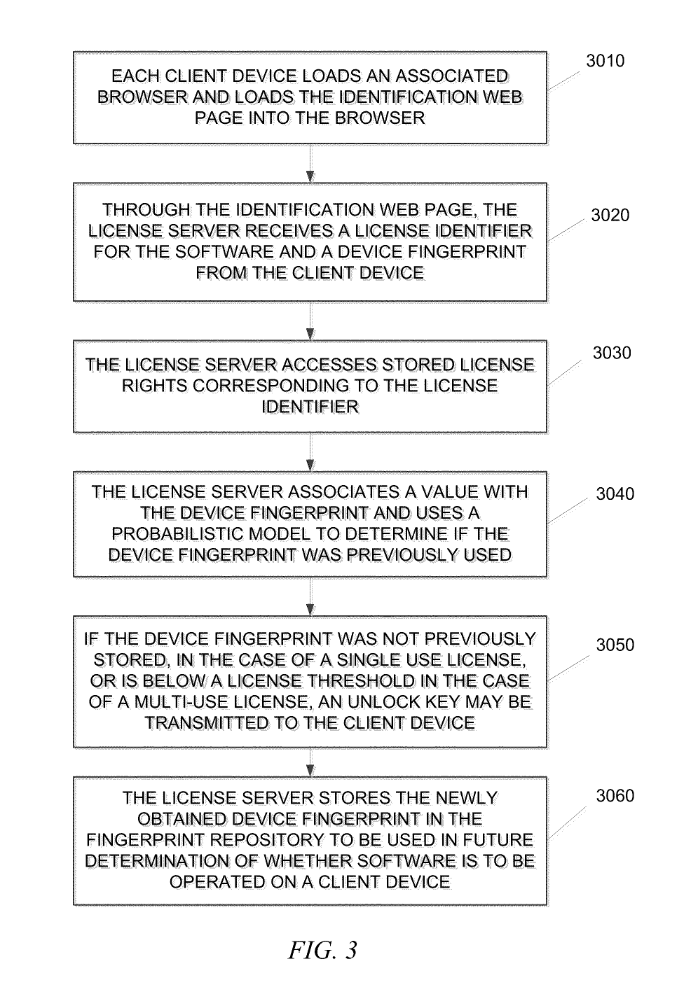

FIG. 3 illustrates an implementation of an embodiment of the invention. At 3010, each client device 220, 230, 240 loads an associated browser and loads the identification web page into the browser. At 3020, through the identification web page, license server 160 receives a license identifier for the software and a device fingerprint from the client device. The license identifier may be a serial number or other data that is uniquely associated with a licensed software or software title. The device fingerprint may be a browser-based forensic fingerprint.

At 3030, license server 160 accesses stored license rights corresponding to the license identifier. The stored license rights provide the basis for the license server 160 to determine whether nor not to allow installation of the software. Such determination may be based on the number of different client devices (e.g., device fingerprints) permitted to install or operate licensed software, a period of time during which the licensed software may be operated, or other measure or parameter of software usage.

According to certain embodiments, the determination may be based on the number of different client devices permitted to install or operate the licensed software. In accordance with these embodiments, the licensed rights may identify a license limit corresponding to the total number of different client devices authorized to operate the licensed software, an actual authorized number of different client devices that have been authorized to operate the licensed software and a listing of such authorized device fingerprints corresponding to the authorized client devices.

At 3040, the license server associates a value with the device fingerprint and uses a probabilistic model to determine if the device fingerprint was previously used. The license server may access the 270 database of licensed rights and to determine if, for example for a given license identifier, the device fingerprint may be re-used because the license identifier is associated with a multi-use license.

At 3050, if the device fingerprint was not previously stored, in the case of a single use license, or is below a license threshold in the case of a multi-use license, an unlock key may be transmitted to the client device. The unlock key may be an unlock code that is configured to allow the licensed software to install or operate on the client device.

At 3060, the license server stores the newly obtained device fingerprint in the fingerprint repository 170/270 to be used in future determination of whether software is to be operated on a client device.

In accordance with aspects of the embodiments described herein, a given client device may generate a device fingerprint that uniquely identifies the client device. The device fingerprint may be generated by a stand-alone program or application that is provided separately from the licensed software or an applet running within a web browser on the client device. Alternatively, the device fingerprint may be generated by a program or application which comprises a part of the licensed software or other software.

The device fingerprint application may include a registration routine that collects information regarding the client device by checking a number of parameters which are expected to be unique to the client device environment. The parameters checked may include, for example, hard disk volume name, user name, device name, user password, hard disk initialization date, etc. The collected information may include information that identifies the hardware comprising the platform on which the web browser runs, such as, for example, CPU number, or unique parameters associated with the firmware in use. The collected information may further include system configuration information, such as amount of memory, type of processor, software or operating system serial number, etc. In the alternative, or in addition, the parameters may checked may include virtual machine specifications. Examples of virtual machine specifications may include, but are not limited to, information relating to virtual processors, virtual BIOS, virtual memory, virtual graphics, virtual IDE drives, virtual SCSI drives, virtual PCI slots, virtual floppy drives, virtual serial (COM) ports, virtual parallel (LPT) ports, virtual key board, virtual mouse and drawing tablets, virtual Ethernet card, virtual networking, virtual sound adapter, etc.

Based on the collected information, the device fingerprint application may generate a device fingerprint that is unique for the client device. The device fingerprint may be generated using a combination of user-configurable and non-user-configurable machine parameters as input to a process that results in the device fingerprint, which may be expressed in digital data as a binary number. Each machine parameter is data determined by a hardware component, software component, or data component specific to the device that the unique identifier pertains to. Machine parameters may be selected based on the target device system configuration such that the resulting device fingerprint has a very high probability (e.g., greater than 99.999%) of being unique to the target device. In addition, the machine parameters may be selected such that the device fingerprint includes at least a stable unique portion up to and including the entire identifier, which has a very high probability of remaining unchanged during normal operation of the target device. Thus, the resulting device fingerprint should be highly specific, unique, reproducible and stable as a result of properly selecting the machine parameters.

The device fingerprint application may also operate on the collected parameters with one or more algorithms to generate the device fingerprint. This process may include at least one irreversible transformation, such as, for example, a cryptographic hash function, such that the input machine parameters cannot be derived from the resulting device fingerprint. Each device fingerprint, to a very high degree of certainty, cannot be generated except by the suitably configured application operating or otherwise having had access to the same field security device for which the device fingerprint was first generated. Conversely, each identifier, again to a very high degree of certainty, can be successfully reproduced by the suitably configured application operating or otherwise having access to the same field security device on which the identifier was first generated.

The device fingerprint application may operate by performing a system scan to determine a present configuration of the field security device. The application may then select the machine parameters to be used as input for generating the unique device fingerprint. Selection of parameters may vary depending on the system configuration. Once the parameters are selected, the application may generate the identifier.

Further, generating the device fingerprint may also be described as generating a device fingerprint and may entail the sampling of physical, non-user configurable properties as well as a variety of additional parameters such as uniquely generated hashes and time sensitive values. Physical device parameters available for sampling may include, for example, unique manufacturer characteristics, carbon and silicone degradation and small device failures.

In addition to the chip benchmarking and degradation measurements, the process for generating a device fingerprint may include measuring physical, non-user-configurable characteristics of disk drives and solid state memory devices. Each data storage device has a large variety of damage and unusable data sectors that are nearly unique to each physical unit. The ability to measure and compare values for damaged sectors and data storage failures provides a method for identifying storage devices.

Device parameter sampling, damage measurement and chip benchmarking make up just a part of device fingerprinting technologies described herein. These tools may be further extended by the use of complex encryption algorithms to convolute the device fingerprint values during transmission and comparisons. Such encryption processes may be used in conjunction with random sampling and key generations.

In accordance with other aspects of the embodiments described herein, one or more of the techniques and methodologies described herein may be performed by embedded applications, platforms, or systems. The methods described herein may be performed by a general-purpose computer system and/or an embedded application or component of a special-purpose apparatus (e.g., traffic controller, traffic signal, surveillance cameras, sensors, detectors, vehicles, vehicle navigation systems, mobile phones, PDAs, etc.).

In one embodiment, the special-purpose device comprises an embedded platform running an embedded Linux operating system (OS) or the like. For example, the unique device identifier or fingerprint for the special-purpose device may be created by collecting and using one or more of the following information: machine model; processor model; processor details; processor speed; memory model; memory total; network model of each Ethernet interface; network MAC address of each Ethernet interface; BlackBox model (e.g., any Flash device); BlackBox serial (e.g., using Dallas Silicone Serial DS-2401 chipset or the like); OS install date; nonce value; nonce time of day; and any other predefined hardware information stored (optionally encrypted) in EEPROM or the like; any variations/combinations thereof.

It is understood that the specific order or hierarchy of steps in the processes disclosed herein in an example of exemplary approaches. Based upon design preferences, it is understood that the specific order or hierarchy of steps in the processes may be rearranged while remaining within the scope of the present disclosure. The accompanying method claims present elements of the various steps in sample order, and are not meant to be limited to the specific order or hierarchy presented.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical discs (e.g., compact disc (CD), digital versatile disc (DVD), etc.), smart cards, and flash memory devices (e.g., Erasable Programmable Read Only Memory (EPROM), card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

The foregoing description has been directed to specific embodiments of this invention. It will be apparent; however, that other variations and modifications may be made to the described embodiments, with the attainment of some or all of their advantages. Therefore, it is the object of the appended claims to cover all such variations and modifications as come within the true spirit and scope of the invention.

What is claimed is:

1. An apparatus, comprising:
a network interface connected to at least one client device through a computer network;
a processor configured to retrieve through the network interface a device fingerprint that uniquely identifies a client device seeking authorization to operate software; and
a memory comprising program instructions executable by the processor to:
associate a value with the retrieved device fingerprint;
probabilistically compare the value to previously stored device fingerprints to determine if the retrieved device fingerprint matches a previously stored device fingerprint;
determine whether total instances of retrieval of the retrieved device fingerprint exceeds a pre-determined threshold established by a license identifier;
authorize a client request for access to software associated with the license identifier if the total instances of retrieval are within the threshold; and
store the retrieved device fingerprint.

2. The apparatus of claim 1 wherein the device fingerprint is retrievable through a web page executed by the client device, and wherein the apparatus is configured to make the web page available for execution.

3. The apparatus of claim 1, wherein the apparatus is configured to examine the client device through an Internet connection and to retrieve information exposed through a browser of the client device.

4. The apparatus of claim 1, wherein the apparatus is configured to apply a probabilistic model to compare the retrieved device fingerprint to the previously stored device fingerprints and to determine whether the retrieved device fingerprint matches a previously stored device fingerprint based on the probabilistic model.

5. The apparatus of claim 1, further comprising a database, accessible by the processor, that stores licensed rights indicated by the license identifier.

6. The apparatus of claim 5, wherein the licensed rights identify the license limit of different client devices authorized to operate the licensed software, an actual authorized number of different client devices authorized to operate the licensed software, and a listing of authorized device fingerprints.

7. A method, comprising steps for:
connecting a server to at least one client device through a computer network;
retrieving a device fingerprint that uniquely identifies a client device seeking authorization to operate software;
associating a value with the retrieved device fingerprint;
probabilistically comparing the value to previously stored device fingerprints and determining if the retrieved device fingerprint matches a previously stored device fingerprint;
determining whether total instances of retrieval of the retrieved device fingerprint exceeds a pre-determined threshold established by a license identifier;
in response to the determining step, authorizing a client request for access to software associated with the license identifier if the number of instances of retrieval is within the threshold; and
storing the retrieved device fingerprint.

8. The method of claim 7 wherein the retrieving step further comprises retrieving the device fingerprint through a web page executed by the client device, and wherein the server is configured to make the web page available for execution.

9. The method of claim 7, wherein the retrieving step comprises examining the client device through an Internet connection and retrieving information exposed through a browser of the client device.

10. The method of claim 7, wherein the comparing step comprises applying a probabilistic model to compare the retrieved device fingerprint to the previously stored device fingerprints and to determine whether the retrieved device fingerprint matches a previously stored device fingerprint based on the probabilistic model.

11. An apparatus, comprising:
means for connecting to at least one client device through a computer network;
means for retrieving a device fingerprint that uniquely identifies a client device seeking authorization to operate software;
means for associating a value with the retrieved device fingerprint;
means for probabilistically comparing the value to previously stored device fingerprints and determining whether the retrieved device fingerprint matches a previously stored device fingerprint;
means for determining whether total instances of retrieval of the retrieved device fingerprint exceeds a pre-determined threshold established by a license identifier;
means for authorizing a client request for access to software associated with the license identifier if the number of instances is within the threshold; and
means for storing the retrieved device fingerprint.

12. The apparatus of claim 11 wherein the means for retrieving comprises means for retrieving the device fingerprint through a web page executed by the client device, wherein the apparatus is configured to make the web page available for execution.

13. The apparatus of claim 11, wherein the means for retrieving comprises means for examining the client device through an Internet connection and retrieving information exposed through a browser of the client device.

14. The apparatus of claim 11, wherein the means for comparing comprises means for applying a probabilistic model to compare the retrieved device fingerprint to the previously stored device fingerprints and to determine whether the retrieved device fingerprint matches a previously stored device fingerprint based on the probabilistic model.

15. The apparatus of claim 11, further comprising means for accessing a database storing licensed rights indicated by the license identifier

16. A computer-readable medium having stored thereon computer-executable instructions that, when executed by a computing device, cause the computing device to perform steps for:
connecting a server to at least one client device through a computer network;
retrieving, by the server, a device fingerprint that uniquely identifies a client device seeking authorization to operate software;
associating, by the server, a value with the retrieved device fingerprint;
probabilistically comparing, by the server, the value to previously stored device fingerprints and determining whether the retrieved device fingerprint matches a previously stored device fingerprint;
determining, by the server, whether total instances of retrieval of the retrieved device fingerprint exceeds a pre-determined threshold established by a license identifier;
in response to the determining step, authorizing, by the server, a client request for access to software associated with the license identifier if the number of times is within the threshold; and
storing, by the server, the retrieved device fingerprint.

17. The computer-readable medium of claim 16 wherein the retrieving step comprises causing the server to make a web page available for execution and to retrieve the device fingerprint through the web page when executed by the client device.

18. The computer-readable medium of claim 16, wherein the retrieving step comprises causing the server to examine the client device through an Internet connection and to retrieve information exposed through a browser of the client device.

19. The computer-readable medium of claim 16, wherein the comparing step comprises applying a probabilistic model to compare the retrieved device fingerprint to the previously stored device fingerprints to determine whether the retrieved device fingerprint matches a previously stored device fingerprint based on the probabilistic model.
